(19) United States
(12) Patent Application Publication
(10) Pub. No.: US 2025/0264380 A1
(43) Pub. Date: Aug. 21, 2025

(54) HIGHLY COMPACT LNG SAMPLING AND GASIFICATION APPARATUS WITH SELF-ADAPTIVE FUNCTION

(71) Applicants: CNOOC GAS & POWER GROUP, Beijing (CN); TECHENG SCIENCE & TECHNOLOGY CO., LTD., Beijing (CN)

(72) Inventors: Chao ZHANG, Beijing (CN); Bing LIU, Beijing (CN); Li XIAO, Beijing (CN); Jing TIAN, Beijing (CN); Liang LAN, Beijing (CN); Fan YANG, Beijing (CN); Haiping CHEN, Beijing (CN); Fang LIU, Beijing (CN); Wenlong TONG, Beijing (CN); Fengfeng PAN, Beijing (CN); Jianhong WU, Beijing (CN); Weikang ZHANG, Beijing (CN); Tao SONG, Beijing (CN); Nan LI, Beijing (CN); Zicheng WANG, Beijing (CN); Yu ZHANG, Beijing (CN); Xin LI, Beijing (CN); Yaxuan FU, Beijing (CN); Wenxi LIN, Beijing (CN)

(21) Appl. No.: 18/857,003

(22) PCT Filed: Apr. 13, 2022
(86) PCT No.: PCT/CN2022/086502

§ 371 Date: Oct. 15, 2024

(51) Int. Cl. G01N 1/20; G01N 1/10

(52) U.S. Cl. CPC G01N 1/2035; G01N 2001/1031; G01N 2001/205

(57) ABSTRACT

An LNG sampling and gasification apparatus with self-adaptive function includes: a sampling inner tube having an inlet connected to a main LNG sampling duct via a pipeline interface flange; a gasification mechanism connected to an outlet of the sampling inner tube to gasify the subcooling LNG sample delivered by the sampling inner tube; a vacuum sleeve sleeved outside the sampling inner tube between the pipeline interface flange and the gasification mechanism, wherein a vacuum heat-insulated space is formed inside the vacuum sleeve; an automatic shut-off valve on the sampling inner tube to control shut-off of the sampling inner tube in an automatic manner; a flow rate control mechanism on the sampling inner tube upstream from the gasification mechanism, and configured to perform flow rate control on the subcooling LNG sample delivered by the sampling inner tube and apply integrity protection on a gasified natural gas sample.

### FIELD OF THE INVENTION

The present disclosure relates to a liquefied natural gas (LNG) sampling and gasification apparatus, in particular to a highly compact LNG sampling and gasification apparatus with self-adaptive function, which belongs to the technical field of LNG sampling and analysis.

### BACKGROUND OF THE INVENTION

With increasing requirements for transformation to green and low-carbon development modes in China, natural gas including liquefied natural gas (LNG), as a clean energy source, is going through a period of rapid development. The growth rate of natural gas output keeps exceeding that of oil. The latest data released by the National Bureau of Statistics shows that China's total natural gas output in 2020 has increased by 9.8% year-on-year to 188.8 billion cubic meters, while crude oil output in the same period was 195 million tons with an increase of only 1.6% over the last year. There are two main reasons for “gas exceeding oil”: First, compared with coal and oil, natural gas has the advantages of being widely used, safe, convenient, high calorific value, clean and environmentally friendly so that it is an important path for China to promote energy production and consumption revolution and also to build a clean, low-carbon, safe and efficient modern energy system; Second, the goal of Peak Carbon Dioxide Emissions has accelerated efficient utilization of clean energy represented by natural gas (including LNG).

Moreover, in order to fully reflect the economic value of high calorific value of natural gas (including LNG), and to safeguard the legitimate rights and interests of operators and users of oil and gas pipeline network facilities, the National Development and Reform Commission formulated the “Measures for the Fair and Opening Supervision and Administration of Oil and Gas Pipeline Network Facilities” (hereinafter referred to as the Measures) in 2019, the Measures clearly require that natural gas should employ calorific value as the basis for trade settlement. In the case that a condition for calorific value metering is not currently available, the calorific value (energy) metering should be enabled within 24 months since the date of implementation of the Measures. As such, there is an increasing demand for LNG sampling, gasification and energy analysis metering apparatus.

As LNG is a liquid mixture of ultra-low temperature (an operating temperature is usually below −150° C.) and is very easy to be gasified, and the liquid LNG is prone to rapid fractionation and gasification under the effect of slight changes in temperature and pressure, it is very difficult to obtain, prior to gasification of LNG, an actual flowing LNG sample that can represent a mixture ratio of the liquid in a pipeline. Any changes in temperature, pressure and environmental conditions can easily lead to premature and incomplete gasification of LNG so that it is impossible to obtain a representative sample. Therefore, the LNG sample must be kept in a subcooled state before the gasification, and no fractionation and gasification of any composition is allowed.

An LNG sampling, gasification and energy analysis metering apparatus uses an LNG sampling probe and a sampling analysis process device integrated in an analysis cabin to perform analysis on compositions and a calorific value of LNG in a pipeline. The analysis includes two types, i.e., real-time online analysis and offline laboratory analysis. The first step to implement the LNG energy analysis and metering is to acquire an intact LNG sample and then gasify it completely and efficiently so as to obtain a representative gaseous natural gas sample, which is used for analyzing compositions of the sample by a chromatographic analyzer. However, the existing LNG sampling and gasification analysis products have the following shortcomings:
\textcircled{1} In terms of inhibiting premature fractionation of the LNG, the existing technology has stated the following facts that: the key for obtaining a representative LNG sample is to ensure that the ultra-low temperature LNG does not undergo fractionation and gasification during sampling so that no deviation from compositions of the LNG sample (especially light compositions such as methane and nitrogen) will be resulted from the premature gasification. After summarizing many LNG sampling failure cases in the past 10 years, the inventor found that insufficient subcooling, lack of integrated design and installation, and poor heat insulation all may lead to the premature gasification that happens before the LNG enters a gasifier, as a result of which the sampling sample is unrepresentative.
\textcircled{2} Most of the existing LNG sampling probes adopt vacuum as a heat insulation method, but none of them have either elaborated on an implementation method of vacuum, in particular a heat insulation method of an isolation valve at the sampling pipeline, or have proposed an efficient and feasible method for improving the vacuum degree. In addition, on the one hand, an existing LNG sampling probe is impossible to observe the vacuum degree of the probe in real time and maintain a high vacuum state, on the other hand, an automatic shut-off valve that is commonly used on a sampling inner tube suffer from cold energy and LNG leakage due to the actions of an executing mechanism.
\textcircled{3} Among the existing technology, it is impossible to enable integrated regulation and control on the sampled liquid flow after sampling of the LNG, and it is prone to bring excessive load to the power of the gasifier in the case of sampling under special conditions or fluctuations in flow rate, pressure and temperature occurred in the sampling conditions.
\textcircled{4} Among the existing technology, measures for protecting the integrity of the gaseous sample are absent after sampling and gasification of the LNG so that the gasified natural gas might return back to LNG liquid region, which not only weaken the representativeness of the gasified sample, but also transfers gaseous heat to the liquid phase of LNG, affecting the cryogenic level of subcooling.

### SUMMARY OF THE INVENTION

In view of the above problems, an objective of the present disclosure is to provide a highly compact LNG sampling and gasification apparatus with self-adaptive function, which can not only maintain a high degree of vacuum and inhibit effectively premature gasification of a LNG sample, but also obtain the LNG sample with its integrity and gasify it into a representative gaseous natural gas sample.

In order to achieve the above objectives, the present disclosure adopts technical solutions as following: a highly compact LNG sampling and gasification apparatus with self-adaptive function, comprising: a sampling inner tube, an inlet end of which is connected to a main LNG sampling duct via a pipeline interface flange, wherein the sampling inner tube is configured to extract a subcooling LNG sample in a pipeline; a gasification mechanism, which is connected to an outlet end of the sampling inner tube and is configured to gasify the subcooling LNG sample delivered by the sampling inner tube; a vacuum sleeve, which is sleeved outside the sampling inner tube that is between the pipeline interface flange and the gasification mechanism, wherein a vacuum heat-insulated space is formed inside the vacuum sleeve; an automatic shut-off valve, which is provided on the sampling inner tube and is configured to control shut-off of the sampling inner tube in an automatic manner; a flow rate control mechanism, which is provided on the sampling inner tube that is located upstream from the gasification mechanism, and is configured to perform flow rate control on the subcooling LNG sample delivered by the sampling inner tube and apply integrity protection on a gasified natural gas sample.

In the highly compact LNG sampling and gasification apparatus, preferably, the flow rate control mechanism comprises: a channel element, in which an inlet channel, an outlet channel and an intermediate channel are formed, wherein the inlet channel and the outlet channel are arranged in a same direction but staggered axes, the inlet channel and the outlet channel are communicated with each other through the intermediate channel, and the intermediate channel is perpendicular to the inlet channel and the outlet channel, respectively; an opening and closing element, which is slidably arranged in the intermediate channel; and a regulating element, which is connected to the opening and closing element, and is configured to provide the opening and closing element with a preload for closing the intermediate channel between the inlet channel and the outlet channel in an initial state and adjust the preload.

In the highly compact LNG sampling and gasification apparatus, preferably, the regulating element comprises: a regulating screw, which is threadedly connected within the intermediate channel that is located outside the opening and closing element, wherein the regulating screw can be rotated in or out within the intermediate channel; a spring, which is connected between the regulating screw and the opening and closing element, wherein one end of the spring is connected to the regulating screw, and another end of the spring is connected to the opening and closing element, the spring is configured to provide the opening and closing element with a preload for closing the intermediate channel in an initial state; and a position indicator, which is connected to an outer end of the regulating screw and is configured to preset a preload related to a maximum stroke position of the spring.

In the highly compact LNG sampling and gasification apparatus, preferably, the position indicator and the regulating screw adjust an effective quantity of turns of the spring according to a formula (1) below to change a stroke of the spring so that a function of controlling a flow rate of the subcooling LNG sample in accordance of an inlet pressure is finally enabled:

$$x = P / K \qquad ( 1 )$$

$$K = ( G * d ) / [ 8 * ( D / d ) \hat{} 3 * n ] \qquad ( 2 )$$

wherein x represents the stroke of the spring; P represents a maximum designed pressure of the medium flowing from the inlet channel; K represents a stiffness of the spring; G represents an elastic coefficient of the spring; d represents a diameter of spring wire of the spring; D represents a mean diameter of the spring; n represents the effective quantity of turns of the spring.

In the highly compact LNG sampling and gasification apparatus, preferably, a maximum opening position of the opening and closing element does not exceed an outer boundary of the outlet channel.

In the highly compact LNG sampling and gasification apparatus, preferably, the gasification mechanism comprises a gasifier heating structure, a temperature control module, an inlet temperature detection element, an inlet pressure detection element, an outlet temperature detection element, and an outlet temperature detection element, an outlet pressure detection element, a flow rate detection element, and an electrical element controller, wherein an inlet end of the gasifier heating structure is connected to the outlet end of the sampling inner tube, an input terminal of the gasifier heating structure is electrically coupled to the temperature control module, and the inlet temperature detection element and the inlet pressure detection element are provided at the inlet end of the gasifier heating structure, the outlet temperature detection element, the outlet pressure detection element and the flow rate detection element are provided at an outlet end of the gasifier heating structure, the electrical element controller is electrically coupled to the temperature control module, the inlet temperature detection element, the inlet pressure detection element, the outlet temperature detection element, the outlet pressure detection element and the flow rate detection element, respectively, and the electrical element controller is connected to a host computer.

In the highly compact LNG sampling and gasification apparatus, preferably, the gasifier heating structure adopts an electrically-heating solid heat transfer structure, and the gasifier heating structure comprises: a spiral coiled channel structure, an inlet end of which is connected to the outlet end of the sampling inner tube; externally-filled heat transfer material, which is wrapped outside of the spiral coiled channel structure; an electrically-heating element, a heating end of which is inserted and arranged in the externally-filled heat transfer material, and an input terminal of which is electrically coupled to the temperature control module.

In the highly compact LNG sampling and gasification apparatus, preferably, whether the subcooling LNG sample entering the gasifier heating structure has been gasified completely is checked according to a detection value of the flow rate detection element, and a check method is that a flow rate of the subcooling LNG sample that has been corrected by the inlet temperature detection element, the inlet pressure detection element, the outlet temperature detection element and the outlet pressure detection element is consistent with a detection value of the gasified natural gas sample detected by the flow rate detection element.

In the highly compact LNG sampling and gasification apparatus, preferably, the automatic shut-off valve comprises: a bracket, one end of which is connected to the vacuum sleeve in a sealing manner via a valve interface flange; a valve core, which is provided on the sampling inner tube; a drive rod, an action end of which passes through the valve interface flange and is then connected to the valve core; a drive unit, which is fastened to another end of the bracket, wherein an output end of the drive unit is connected to an input end of the drive road, and a control end of the drive unit is electrically coupled to the host computer; and an elastic threaded sleeve, which is sleeved outside the drive rod that is located between the valve interface flange and the drive unit, wherein one end of the elastic threaded sleeve is in contact with an outer end surface of the valve interface flange, another end of the elastic threaded sleeve is in contact with an inner end surface of the drive unit, and elastic dynamic seal is formed at contact interfaces between the elastic threaded sleeve (3-5) and the two, respectively.

In the highly compact LNG sampling and gasification apparatus, preferably, a support member is provided outside the drive rod that is located inside the valve interface flange, one end of the support member is connected to the drive rod in a movable manner, and another end of the support member is connected to an inner tube wall of the vacuum sleeve in a fastened manner.

In the highly compact LNG sampling and gasification apparatus, preferably, when an LNG sample of ultra-low temperature is extracted from the main LNG sampling duct by using the sampling inner tube, a control method of the automatic shut-off valve is that: detecting in real time an inlet temperature, an outlet temperature, an inlet pressure and an outlet pressure of the gasification mechanism by the inlet temperature detection element, the outlet temperature detection element, the inlet pressure detection element and the outlet pressure detection element, and transmitting them to the host computer, wherein in the case that the inlet temperature or inlet pressure of the gasification mechanism is higher than a high interlock set value or that the outlet temperature or outlet pressure of the gasification mechanism is lower than a low interlock set value, the host computer controls the drive unit in linkage with the drive rod to drive the valve core to act to enable automatic shut-off of the automatic shut-off valve.

In the highly compact LNG sampling and gasification apparatus, preferably, the vacuum sleeve is provided with a self-sealing vacuumizing port, the self-sealing vacuumizing port is connected to a vacuum pump;

A vacuum measuring element is provided within the vacuum sleeve that is located near the self-sealing vacuumizing port, and the vacuum measuring element is electrically coupled to the host computer.

The present disclosure has the following advantages by using the above technical solutions:
1, In the present disclosure, a flow rate control mechanism is provided on the sampling inner tube that is located upstream from the gasification mechanism. Said flow rate control mechanism has both the functions of flow rate control and natural gas backflow inhibition so that it is possible to not only control a flow rate of a subcooling LNG sample delivered by the sampling inner tube, but also protect the integrity of a gasified natural gas sample.
2, In the present disclosure, an independent gasification mechanism has been designed to realize efficient and complete transformation of the LNG sample from liquid to gas without additional devices and related accessories, that is, to implement functions including LNG sampling, gasification, and check and computation on gasification integrity so that shortcomings of the existing technology can be compensated.
3, In the present disclosure, in accordance of a range of regulating a flow entering the gasification mechanism, an internal fluid-retention preventing structure is designed innovatively, the minimum heating power is accurately calculated, and control parameters and control methods are optimized and determined, so that it is ensured from the three aspects that LNG in various sampling conditions can be gasified efficiently and completely in a gasification heating element.
4, In the present disclosure, an integrated structure has been adopted to improve structures from a LNG sampling structure to the front of a gasification mechanism, which has a self-adaptive function and can maintain a high degree of vacuum, effectively inhibits premature gasification of the LNG sample, and ensures the representativeness of the sample.
5, In the present disclosure, a traditional corrugated seal design has been improved by wrapping the drive rod with an elastic threaded structure, thereby enabling dynamic vacuum seal while the drive rod moves, ensuring that neither cool energy nor combustible gas leaks and escapes into the air while the drive rod moves freely, retaining a subcooling degree to the greatest extent during the LNG sampling process, preventing the LNG sample from premature fractionation, and meeting a requirement regarding a subcooling temperature in advance of gasification of the LNG.
6, In the present disclosure, a self-sealing vacuumizing port connected to a vacuum pump is provided on the vacuum sleeve, and a host computer is adopted to monitor a vacuum degree in real time and activate the vacuum pump, so that a high degree of vacuum is ensured within the vacuum sleeve and is maintained at 50 mbar, which is better than levels of similar kinds.

### BRIEF DESCRIPTION OF THE DRAWINGS

FIG. 1 is a schematic diagram of a structure of an LNG sampling and gasification apparatus provided by an embodiment of the present disclosure;

FIG. 2 is a schematic diagram of a structure of a flow rate control mechanism provided by an embodiment of the present disclosure;

FIG. 3 is a schematic diagram of a structure of a gasification mechanism provided by an embodiment of the present disclosure; and

FIG. 4 is a schematic diagram of a structure of an automatic shut-off valve provided by an embodiment of the present disclosure.

Respective reference numbers in the figures include:
1—flow rate control mechanism; 2—manual shut-off valve; 3—automatic shut-off valve; 4—sampling inner tube; 5—self-sealing vacuumizing port; 6—vacuum pump; 7—vacuum sleeve; 8—vacuum measuring element; 9—gasification mechanism; 10—pipeline interface flange; 20—valve interface flange;
11—channel element; 12—opening and closing element; 13—regulating element; 1-1—inlet channel; 1-2—outlet channel; 1-3—intermediate channel; 13-1—regulating screw; 13-2—spring; 13-3—position indicator;
3-1—bracket; 3-2—valve core; 3-3—drive rod; 3-4—drive unit; 3-5—elastic threaded sleeve; 3-6—support member;
91—gasifier heating structure; 92—temperature control module; 93—inlet temperature detection element; 94—inlet pressure detection element; 95—outlet temperature detection element; 96—outlet pressure detection element; 97—flow rate detection element; 98—electrical element controller; 91-1—spiral coiled channel structure; 91-2—externally-filled heat transfer material; 91-3—electrically-heating element.

### DETAILED DESCRIPTION OF THE EMBODIMENTS

In order to make the objectives, technical solutions and advantages of the present disclosure more definite, the technical solutions of the present disclosure will be described below in a clear and complete manner with reference to the accompanying drawings. Apparently, the described embodiments are partial, but not all, embodiments of the present disclosure. Based on the embodiments of the present disclosure, all other embodiments obtained by those of ordinary skill in the art without creative works shall fall within the protection scope of the present disclosure.

In the description of the present disclosure, it should be noted that the orientations or positional relationships indicated by the terms “upper”, “lower”, “inner”, “outer”, “horizontal”, “vertical”, etc. refer to the orientations or positional relationships shown in the figures, which are only for the convenience of describing the present disclosure and simplifying the description, other than indicating or implying that the referred system or element must have a specific orientation and be constructed and operated in a specific orientation, and therefore should not be construed as a limitation of the present disclosure. In addition, the terms “first”, “second” and the like are used to define parts and components, and are only for the convenience of distinguishing these parts and components. Unless otherwise stated, the above wordings have no special meaning and should not be construed as indicating or implying relative importance.

In the description of the present disclosure, it should be noted that, unless otherwise expressly specified and defined, the wordings “assembly,” “arrange,” “connect” should be understood in a broad sense. For example, it can be fixed connection, detachable connection, or integrated connection; it can be mechanical connection, and also electrical connection; it can be directly connected, indirectly connected through an intermediate medium, or internal communication between two elements. For those of ordinary skill in the art, the specific meanings of the above terms in the present disclosure can be understood according to specific scenarios.

A highly compact LNG sampling and gasification apparatus with self-adaptive function provided by the present disclosure includes: a sampling inner tube, an inlet end of which is connected to an main LNG sampling duct through a pipeline interface flange; a gasification mechanism, which is connected to an outlet end of the sampling inner tube and is configured to gasify the subcooling LNG sample delivered by the sampling inner tube; a vacuum sleeve, which is sleeved outside the sampling inner tube that is between the pipeline interface flange and the gasification mechanism, wherein a vacuum heat-insulated space is formed inside the vacuum sleeve; an automatic shut-off valve, which is provided on the sampling inner tube and is configured to control shut-off of the sampling inner tube in an automatic manner; a flow rate control mechanism, which is provided on the sampling inner tube that is located upstream from the gasification mechanism, and is configured to perform flow rate control on the subcooling LNG sample delivered by the sampling inner tube and apply integrity protection on a gasified natural gas sample. The present disclosure can not only maintain a high degree of vacuum and inhibit effectively premature gasification of the LNG sample, but also obtain the LNG sample with its integrity and gasify it into a representative gaseous natural gas sample.

Hereinafter, the highly compact LNG sampling and gasification apparatus with self-adaptive function provided by the embodiments of the present disclosure will be described in detail with reference to the accompanying drawings.

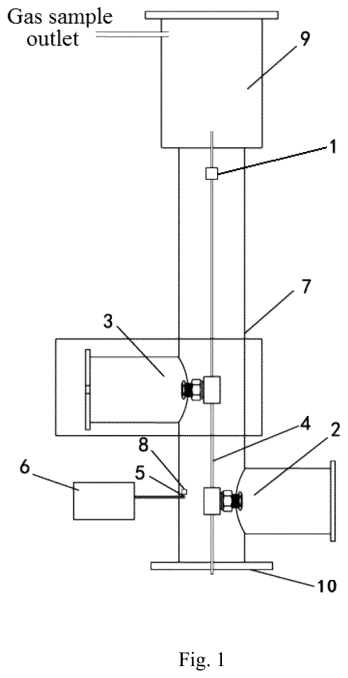

As shown in FIG. 1, a highly compact LNG sampling and gasification apparatus with self-adaptive function provided by the present disclosure includes: a sampling inner tube 4, wherein an inlet end of sampling inner tube 4 is connected to a main LNG sampling duct (not shown in the figure) via a pipeline interface flange 10, and the sampling inner tube 4 is configured to extract a LNG sample in the pipeline; a gasification mechanism 9, which is connected to an outlet end of the sampling inner tube 4 and is configured to gasify a subcooling LNG sample delivered by the sampling inner tube 4; a vacuum sleeve 7, which is sleeved outside the sampling inner tube 4 that is between the pipeline interface flange 10 and the gasification mechanism 9, wherein a vacuum heat-insulated space is formed inside the vacuum sleeve 7; a manual shut-off valve 2, which is provided on the sampling inner tube 4 and is configured to control shut-off of the sampling inner tube 4 in a manual manner; an automatic shut-off valve 3, which is also provided on the sampling inner tube 4 and is configured to control shut-off of the sampling inner tube 4 in an automatic manner; a flow rate control mechanism 1, which is provided on the sampling inner tube 4 that is located upstream from the gasification mechanism 9 and is configured to perform flow rate control on the subcooling LNG sample delivered by the sampling inner tube 4 and apply integrity protection on a gasified natural gas sample.

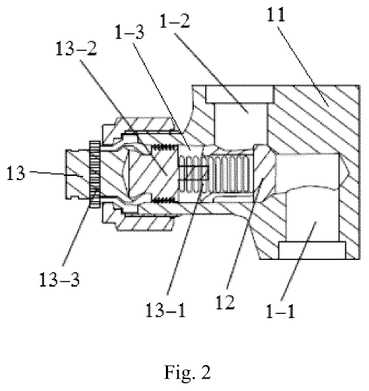

As shown in FIG. 2, the flow rate control mechanism 1 includes: a channel element 11, in which an inlet channel 1-1, an outlet channel 1-2 and an intermediate channel 1-3 are formed, wherein the inlet channel 1-1 and the outlet channel 1-2 are arranged in the same direction but staggered axes, the inlet channel 1-1 and the outlet channel 1-2 are communicated with each other through the intermediate channel 1-3, and the intermediate channel 1-3 is perpendicular to the inlet channel 1-1 and the outlet channel 1-2, respectively; an opening and closing element 12, which is slidably arranged in the intermediate channel 1-3; a regulating element 13, which is connected to the opening and closing element 12, and is configured to provide the opening and closing element 12 with a preload for closing the intermediate channel 1-3 between the inlet channel 1-1 and the outlet channel 1-2 in an initial state and adjust the preload. Thus, after the subcooling LNG sample delivered by the sampling inner tube 4 flows into the inlet channel 1-1, the opening and closing element 12 is lifted to open the intermediate channel 1-3, and then the subcooling LNG sample flows into the gasification mechanism 9 through the outlet channel 1-2. Further, the preload can be adjusted and preset by the regulating element 13 to control the opening and closing element 12 so as to control a flow rate of the subcooling LNG sample entering the outlet channel 1-2 in a quantitative manner.

In the above embodiment, preferably, the regulating element 13 includes: a regulating screw 13-1, which is threadedly connected within the intermediate channel 1-3 that is located outside the opening and closing element 12, and can be rotated in or out within the intermediate channel 1-3; a spring 13-2, which is connected between the regulating screw 13-1 and the opening and closing element 12, wherein one end of the spring 13-2 is connected to the regulating screw 13-1, and the other end of the spring 13-2 is connected to the opening and closing element 12, the spring 13-2 is configured to provide the opening and closing element 12 with a preload for closing the intermediate channel 1-3 in the initial state; a position indicator 13-3, which is connected to an outer end of the regulating screw 13-1, and is configured to preset a preload related to a maximum stroke position of the spring 13-2. Therefore, by rotating the position indicator 13-3 to screw in or out the regulating screw 13-1, the maximum stroke position of the spring 13-2 is adjusted to control a maximum opening position of the opening and closing element 12 so that the flow rate of the subcooling LNG sample flowing from the inlet channel 1-1 into the outlet channel 1-2 can be controlled in a quantitative manner.

In the above embodiment, preferably, the position indicator 13-3 and the regulating screw 13-1 adjust the effective number of turns of the spring 13-2 according to the following formula (1) to change the stroke of the spring 13-2 so that the function of controlling the flow rate of the subcooling LNG sample in accordance of an inlet pressure is finally enabled:

$$x = P / K \qquad ( 1 )$$

$$K = ( G * d ) / [ 8 * ( D / d ) \hat{} 3 * n ] \qquad ( 2 )$$

In the formulas, x represents a stroke of the spring 13-2; P represents a maximum designed pressure of the medium flowing from the inlet channel 1-1; K represents a stiffness of the spring 13-2; G represents an elastic coefficient of the spring 13-2, a value of which is determined according to selection of a designed condition; d represents a diameter of spring wire of the spring 13-2; D represents a mean diameter of the spring 13-2; n represents the effective number of turns of the spring 13-2.

In the above embodiment, preferably, no matter what level the preload is, the maximum opening position of the opening and closing element 12 does not exceed an outer boundary of the outlet channel 1-2 so that the opening and closing element 12 can be pushed to close the intermediate channel 1-3 in the case that the natural gas sample that has been gasified flows back to the outlet channel 1-2. As such, the natural gas sample is prevented from returning to the inlet channel 1-1 so as to realize protection for the integrity of the gasified natural gas sample.

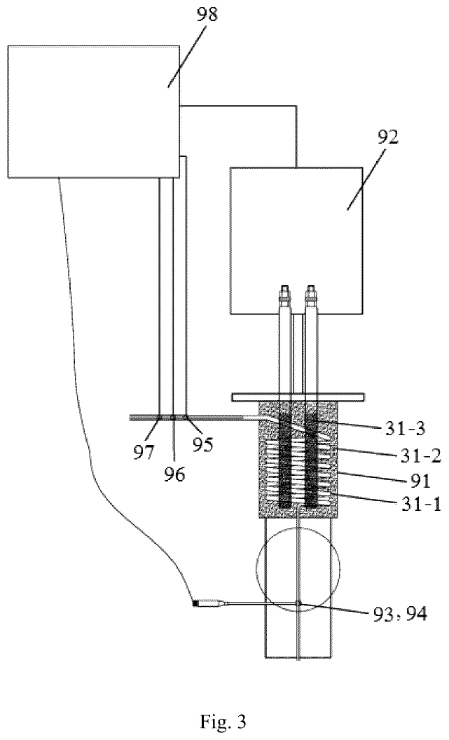

In the above embodiment, preferably, as shown in FIG. 3, the gasification mechanism 9 includes a gasifier heating structure 91, a temperature control module 92, an inlet temperature detection element 93, an inlet pressure detection element 94, an outlet temperature detection element 95, and an outlet temperature detection element 95, an outlet pressure detection element 96, a flow rate detection element 97, and an electrical element controller 98. In this case, an inlet end of the gasifier heating structure 91 is connected to the outlet end of the sampling inner tube 4, an input terminal of the gasifier heating structure 91 is electrically coupled to the temperature control module 92, and the inlet temperature detection element 93 and the inlet pressure detection element 94 are provided at the inlet end of the gasifier heating structure 91. The outlet temperature detection element 95, the outlet pressure detection element 96 and the flow rate detection element 97 are provided at an outlet end of the gasifier heating structure 91. The electrical element controller 98 is electrically coupled to the temperature control module 92, the inlet temperature detection element 93, the inlet pressure detection element 94, the outlet temperature detection element 95, the outlet pressure detection element 96 and the flow rate detection element 97, respectively, and the electrical element controller 98 is connected to a host computer (not shown in the figure).

In the above embodiment, preferably, the gasifier heating structure 91 adopts an electrically-heating solid heat transfer structure, and the gasifier heating structure 91 includes: a spiral coiled channel structure 91-1, an inlet end of which is connected to the outlet end of the sampling inner tube 4; externally-filled heat transfer material 91-2, which is wrapped outside of the spiral coiled channel structure 91-1; an electrically-heating element 91-3, a heating end of which is inserted and arranged in the externally-filled heat transfer material 91-2, and an input terminal of which is electrically coupled to the temperature control module 92. Thus, the externally-filled heat transfer material 91-2 is heated by the electrically-heating element 91-3 and transfers heat to the spiral coiled channel structure 91-1 so that fast and efficient heating of the subcooling LNG sample can be meet. At the same time, the electrical element controller 98 automatically adjusts the power of the electrically-heating element 91-3 through the temperature control module 92 according to temperature values of the inlet temperature detection element 93 and the outlet temperature detection element 95. A range of the power of the electrically-heating element 91-3 is set as 500-800W, which is calculated and obtained by performing detailed statistics on ranges of pressure, flow rate, and compositions of all working conditions in the field of LNG while taking safety requirements into consideration.

In the above embodiment, preferably, whether the subcooling LNG sample entering the gasifier heating structure 91 has been gasified completely is checked according to a detection value of the flow rate detection element 97, and a check method thereof lies in that a flow rate of the subcooling LNG sample that has been corrected by the inlet temperature detection element 93, the inlet pressure detection element 94, the outlet temperature detection element 95 and the outlet pressure detection element 96 is consistent with a detection value of the gasified natural gas sample detected by the flow rate detection element 97.

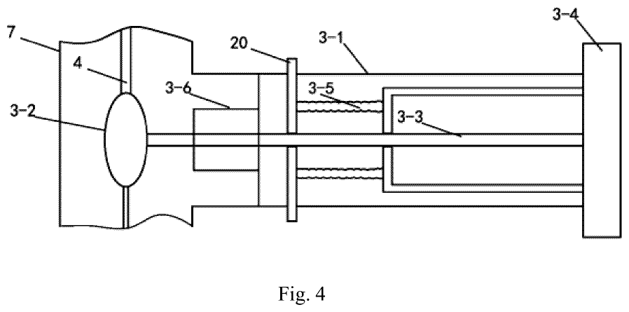

In the above embodiment, preferably, as shown in FIG. 4, the automatic shut-off valve 3 includes a bracket 3-1, a valve core 3-2, a drive rod 3-3, a drive unit 3-4, and an elastic threaded sleeve 3-5. One end of the bracket 3-1 is connected to the vacuum sleeve 7 in a sealing manner via a valve interface flange 20, the drive unit 3-4 is fastened to the other end of the bracket 3-1, and a control end of the drive unit 3-4 is electrically coupled to the host computer. The valve core 3-2 is provided on the sampling inner tube 4, an action end of the drive road 3-3 passes through the valve interface flange 20 and is then connected to the valve core 3-2, and an input end of the drive road 3-3 is connected to an output end of the drive unit 3-4. The elastic threaded sleeve 3-5 is sleeved outside the drive rod 3-3 that is located between the valve interface flange 20 and the drive unit 3-4, wherein one end of the elastic threaded sleeve 3-5 is in contact with an outer end surface of the valve interface flange 20, the other end of the elastic threaded sleeve 3-5 is in contact with an inner end surface of the drive unit 3-4, and elastic dynamic seal is formed at contact interfaces between the elastic threaded sleeve 3-5 and the two, respectively. As such, when an LNG sample of ultra-low temperature is extracted from the main LNG sampling duct by using the sampling inner tube 4, a control method of the automatic shut-off valve 3 is that: an inlet temperature, an outlet temperature, an inlet pressure and an outlet pressure of the gasification mechanism 9 are detected in real time by the inlet temperature detection element 93, the outlet temperature detection element 95, the inlet pressure detection element 94 and the outlet pressure detection element 96, and then transmitted to the host computer; in the case that the inlet temperature or inlet pressure of the gasification mechanism 9 is higher than a high interlock set value or that the outlet temperature or outlet pressure of the gasification mechanism 9 is lower than a low interlock set value, the host computer controls the drive unit 3-4 in linkage with the drive rod 3-3 to drive the valve core 3-2 to act to enable automatic shut-off of the automatic shut-off valve 3, thereby achieving the purpose of cutting off delivery of the medium. At the same time, as the elastic threaded sleeve 3-5 wraps the drive road 3-3, the effect of vacuum compensation for movement of the drive road 3-3 can be taken and an self-adaptive dynamic vacuum seal is enabled while the drive road 3-3 moves so that a part of the automatic shut-off valve 3 that is located within the vacuum sleeve 7 and a part that is located outside the vacuum sleeve 7 form an isolated coupling. As a result, it is ensured that cold energy and combustible gas will not leak and escape into the air while the drive road 3-3 moves freely, thereby protecting the degree of subcooling to the greatest extent during the LNG sampling process, and preventing the LNG sample from premature gasification.

In the above embodiment, preferably, a support member 3-6 is provided outside the drive rod 3-3 that is located inside the valve interface flange 20. One end of the support member 3-6 is connected to the drive rod 3-3 in a movable manner, and the other end of the support member 3-6 is connected to an inner tube wall of the vacuum sleeve 7 in a fastened manner, so that it is possible to enhance comprehensive performance between the drive road 3-3 and the vacuum sleeve 7 and adapt to special working conditions, such as ultra-low temperature vibration.

In the above embodiment, preferably, the vacuum sleeve 7 is provided with a self-sealing vacuumizing port 5. The self-sealing vacuumizing port 5 is connected to a vacuum pump 6 so that the vacuum sleeve 7 is vacuumized by the vacuum pump 6 to form a vacuum heat-insulated space.

In the above embodiment, preferably, a vacuum measuring element 8 is provided in the vacuum sleeve 7 that is located near the self-sealing vacuumizing port 5, and the vacuum measuring element 8 is electrically coupled to the host computer so that a vacuum degree of the vacuum sleeve 7 measured by the vacuum measuring element 8 in real time is uploaded to the host computer. The host computer monitors the vacuum degree in real time and set key control parameters. Once the vacuum degree in the vacuum sleeve 7 is higher than a set value, the vacuum pump 6 is activated to pump to maintain a high vacuum degree in the vacuum sleeve 7.

Finally, it should be noted that the above embodiments are intent to provide illustration only for the technical solutions of the present disclosure, instead of limitation thereto. Although the present disclosure has been described in detail with reference to the above embodiments, it should be understand by those of ordinary skill in the art that modifications still can be made to the technical solutions described in the various foregoing embodiments, or equivalent replacements can still be made to some technical features thereof; and that the essence of the technical solutions related to these modifications or replacements do not deviate from the spirit and scope of the technical solutions of the embodiments of the present disclosure.

1. A highly compact liquefied natural gas, LNG, sampling and gasification apparatus with self-adaptive function, comprising:
a sampling inner tube, an inlet end of which is connected to a main LNG sampling duct via a pipeline interface flange, wherein the sampling inner tube is configured to extract a subcooling LNG sample in a pipeline;
a gasification mechanism, which is connected to an outlet end of the sampling inner tube and is configured to gasify the subcooling LNG sample delivered by the sampling inner tube;
a vacuum sleeve, which is sleeved outside the sampling inner tube that is between the pipeline interface flange and the gasification mechanism, wherein a vacuum heat-insulated space is formed inside the vacuum sleeve;
an automatic shut-off valve, which is provided on the sampling inner tube and is configured to control shut-off of the sampling inner tube in an automatic manner;
a flow rate control mechanism, which is provided on the sampling inner tube that is located upstream from the gasification mechanism, and is configured to perform flow rate control on the subcooling LNG sample delivered by the sampling inner tube and apply integrity protection on a gasified natural gas sample.

2. The highly compact LNG sampling and gasification apparatus according to claim 1, wherein, the flow rate control mechanism comprises:
a channel element, in which an inlet channel, an outlet channel and an intermediate channel are formed, wherein the inlet channel and the outlet channel are arranged in a same direction but staggered axes, the inlet channel and the outlet channel are communicated with each other through the intermediate channel, and the intermediate channel is perpendicular to the inlet channel and the outlet channel, respectively;
an opening and closing element, which is slidably arranged in the intermediate channel; and
a regulating element, which is connected to the opening and closing element, and is configured to provide the opening and closing element with a preload for closing the intermediate channel between the inlet channel and the outlet channel in an initial state and adjust the preload.

3. The highly compact LNG sampling and gasification apparatus according to claim 2, wherein, the regulating element comprises:
a regulating screw, which is threadedly connected within the intermediate channel that is located outside the opening and closing element, wherein the regulating screw can be rotated in or out within the intermediate channel;
a spring, which is connected between the regulating screw and the opening and closing element, wherein one end of the spring is connected to the regulating screw, and another end of the spring is connected to the opening and closing element, the spring is configured to provide the opening and closing element with a preload for closing the intermediate channel in an initial state; and
a position indicator, which is connected to an outer end of the regulating screw and is configured to preset a preload related to a maximum stroke position of the spring.

4. The highly compact LNG sampling and gasification apparatus according to claim 3, wherein, the position indicator and the regulating screw adjust an effective quantity of turns of the spring according to a formula below to change a stroke of the spring so that a function of controlling a flow rate of the subcooling LNG sample in accordance of an inlet pressure is finally enabled:
$$x = P / K \qquad ( 1 )$$
$$K = ( G * d ) / [ 8 * ( D / d ) \hat{} 3 * n ] \qquad ( 2 )$$
wherein x represents the stroke of the spring; P represents a maximum designed pressure of the medium flowing from the inlet channel; K represents a stiffness of the spring; G represents an elastic coefficient of the spring; d represents a diameter of spring wire of the spring: D represents a mean diameter of the spring; n represents the effective quantity of turns of the spring.

5. The highly compact LNG sampling and gasification apparatus according to claim 3, wherein, a maximum opening position of the opening and closing element does not exceed an outer boundary of the outlet channel.

6. The highly compact LNG sampling and gasification apparatus according to claim 1, wherein, the gasification mechanism comprises comprises a gasifier heating structure, a temperature control module, an inlet temperature detection element, an inlet pressure detection element, an outlet temperature detection element, and an outlet temperature detection element, an outlet pressure detection element, a flow rate detection element, and an electrical element controller,
wherein an inlet end of the gasifier heating structure is connected to the outlet end of the sampling inner tube, an input terminal of the gasifier heating structure is electrically coupled to the temperature control module, and the inlet temperature detection element and the inlet pressure detection element are provided at the inlet end of the gasifier heating structure, the outlet temperature detection element, the outlet pressure detection element and the flow rate detection element are provided at an outlet end of the gasifier heating structure, the electrical element controller is electrically coupled to the temperature control module, the inlet temperature detection element, the inlet pressure detection element, the outlet temperature detection element, the outlet pressure detection element and the flow rate detection element, respectively, and the electrical element controller is connected to a host computer.

7. The highly compact LNG sampling and gasification apparatus according to claim 6, wherein, the gasifier heating structure adopts an electrically-heating solid heat transfer structure, and the gasifier heating structure comprises:
a spiral coiled channel structure, an inlet end of which is connected to the outlet end of the sampling inner tube;
externally-filled heat transfer material, which is wrapped outside of the spiral coiled channel structure;
an electrically-heating element, a heating end of which is inserted and arranged in the externally-filled heat transfer material, and an input terminal of which is electrically coupled to the temperature control module.

8. The highly compact LNG sampling and gasification apparatus according to claim 6, wherein, whether the subcooling LNG sample entering the gasifier heating structure has been gasified completely is checked according to a detection value of the flow rate detection element, and a check method is that a flow rate of the subcooling LNG sample that has been corrected by the inlet temperature detection element, the inlet pressure detection element, the outlet temperature detection element and the outlet pressure detection element is consistent with a detection value of the gasified natural gas sample detected by the flow rate detection element.

9. The highly compact LNG sampling and gasification apparatus according to claim 6, wherein, the automatic shut-off valve comprises:
a bracket, one end of which is connected to the vacuum sleeve in a sealing manner via a valve interface flange;
a valve core, which is provided on the sampling inner tube;
a drive rod, an action end of which passes through the valve interface flange and is then connected to the valve core;
a drive unit, which is fastened to another end of the bracket, wherein an output end of the drive unit is connected to an input end of the drive road, and a control end of the drive unit is electrically coupled to the host computer; and
an elastic threaded sleeve, which is sleeved outside the drive rod that is located between the valve interface flange and the drive unit, wherein one end of the elastic threaded sleeve is in contact with an outer end surface of the valve interface flange, another end of the elastic threaded sleeve is in contact with an inner end surface of the drive unit, and elastic dynamic seal is formed at contact interfaces between the elastic threaded sleeve and the valve interface flange, the drive unit, respectively.

10. The highly compact LNG sampling and gasification apparatus according to claim 9, wherein, a support member is provided outside the drive rod that is located inside the valve interface flange, one end of the support member is connected to the drive rod in a movable manner, and another end of the support member is connected to an inner tube wall of the vacuum sleeve in a fastened manner.

11. The highly compact LNG sampling and gasification apparatus according to claim 9, wherein, when an LNG sample of ultra-low temperature is extracted from the main LNG sampling duct by using the sampling inner tube, a control method of the automatic shut-off valve is that: detecting in real time an inlet temperature, an outlet temperature, an inlet pressure and an outlet pressure of the gasification mechanism by the inlet temperature detection element, the outlet temperature detection element, the inlet pressure detection element and the outlet pressure detection element, and transmitting them to the host computer, wherein in the case that the inlet temperature or inlet pressure of the gasification mechanism is higher than a high interlock set value or that the outlet temperature or outlet pressure of the gasification mechanism is lower than a low interlock set value, the host computer controls the drive unit in linkage with the drive rod to drive the valve core to act to enable automatic shut-off of the automatic shut-off valve.

12. The highly compact LNG sampling and gasification apparatus according to claim 6, wherein, the vacuum sleeve is provided with a self-sealing vacuumizing port, the self-sealing vacuumizing port is connected to a vacuum pump;
a vacuum measuring element is provided within the vacuum sleeve that is located near the self-sealing vacuumizing port, and the vacuum measuring element is electrically coupled to the host computer.
